(19) United States
(12) Patent Application Publication
(10) Pub. No.: US 2017/0105056 A1
(43) Pub. Date: Apr. 13, 2017

(54) BULK TELEPHONY CONTROL SYSTEM SUBSCRIBER DATA MANIPULATION

(71) Applicant: Broadsource Group Pty Ltd, Melbourne (AU)

(72) Inventors: Haydn Faltyn, Melbourne (AU); Michael Gliana, Melbourne (AU)

(21) Appl. No.: 15/238,700

(22) Filed: Aug. 16, 2016

Related U.S. Application Data
(60) Provisional application No. 62/240,667, filed on Oct. 13, 2015.

(51) Int. Cl. H04Q 3/00; H04Q 3/62

(52) U.S. Cl. CPC H04Q 3/002; H04Q 3/625

(57) ABSTRACT

A system for bulk telephony control system subscriber data manipulation, comprising an EMU server that receives a plurality of telephony control system subscriber data, analyzes at least a portion of the information, determines whether to modify at least a portion of the telephony control system subscriber data, the determination being based at least in part on the analysis, applies any determined modifications to at least a portion of the telephony control system subscriber data, and provides at least a portion of the information as output, and a method for bulk telephony control system subscriber data manipulation using an EMU server.

### CROSS-REFERENCE TO RELATED APPLICATIONS

This application claims the benefit of, and priority to, U.S. provisional patent application Ser. No. 62/240,667, titled “BULK PBX SUBSCRIBER DATA MANIPULATION” and filed on Oct. 13, 2015, the entire specification of which is incorporated herein by reference in its entirety.

### BACKGROUND OF THE INVENTION

Field of the Art

The disclosure relates to the field of business communication, and more particularly to the field of managing information within a telephone private branch exchange or other telephony control system.

Discussion of the State of the Art

In business communication, it is common for a business to operate a telephony private branch exchange (PBX) or other telephony control system to manage call routing and switching for their organization. Often, telephony control system service providers need to perform large-scale operations on subscriber information, such as mass customer information audits, updating information, perform backup or restore operations, perform bulk provisioning for subscribers, or perform migrations such as to move subscribers across enterprises or redistribute subscribers for system load-balancing. These bulk operations are costly and time-intensive, as they are performed as repeated executions of single operations rather than a more scalable, optimized operation for large data volume

What is needed is a system for bulk telephony control system subscriber data manipulation that extracts, manipulates, and updates telephony control system subscriber data in a manner that is scalable and optimized for large-scale operation.

### SUMMARY OF THE INVENTION

Accordingly, the inventor has conceived and reduced to practice, in a preferred embodiment of the invention, a system and methods for bulk telephony control system subscriber data manipulation, that is configured to extract, manipulate, and update telephony control system subscriber data in a manner that is optimized for large-scale data operations and scalable to arbitrarily large deployments.

According to a preferred embodiment, a system for bulk telephony control system subscriber data manipulation, comprising an extraction, manipulation, and update (EMU) server comprising at least a plurality of programming instructions stored in a memory and operating on a processor of a network-connected computing device and configured to receive a plurality of information via a network, at least a portion of the information comprising telephony control system subscriber data, analyze at least a portion of the information, determine whether to modify at least a portion of the telephony control system subscriber data, the determination being based at least in part on the analysis, apply any determined modifications to at least a portion of the telephony control system subscriber data, and provide at least a portion of the information as output; and a plurality of communication adapters, each comprising at least a plurality of programming instructions stored in a memory and operating on a processor of a network-connected computing device and configured to facilitate communication between the EMU server and a third-party system, is disclosed.

According to another preferred embodiment, a method for bulk telephony control system subscriber data manipulation, comprising the steps of receiving, at an extraction, manipulation, and update (EMU) server comprising at least a plurality of programming instructions stored in a memory and operating on a processor of a network-connected computing device and configured to receive a plurality of information via a network, at least a portion of the information comprising telephony control system subscriber data, analyze at least a portion of the information, determine whether to modify at least a portion of the telephony control system subscriber data, the determination being based at least in part on the analysis, apply any determined modifications to at least a portion of the telephony control system subscriber data, and provide at least a portion of the information as output, a plurality of information; extracting at least a plurality of telephony control system subscriber data from the information; applying a plurality of data manipulations to at least a portion of the telephony control system subscriber data; and providing at least a portion of the telephony control system subscriber data as output, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is an overview of an exemplary system architecture for bulk telephony control system subscriber data manipulation, according to a preferred embodiment of the invention.

FIG. 6 is a flow diagram illustrating an exemplary telephony control system migration process using bulk data manipulation, according to a preferred embodiment of the invention.

FIG. 7 is a more detailed system architecture diagram of an extraction, manipulation, and update (EMU) server, illustrating the use of communication adapters and processing modules for EMU operations.

### DETAILED DESCRIPTION

The inventor has conceived, and reduced to practice, in a preferred embodiment of the invention, a system and methods for bulk telephony control system subscriber data manipulation, that is configured to extract, manipulate, and update telephony control system subscriber data in a manner that is optimized for large-scale data operations and scalable to arbitrarily large deployments.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, wearable device, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

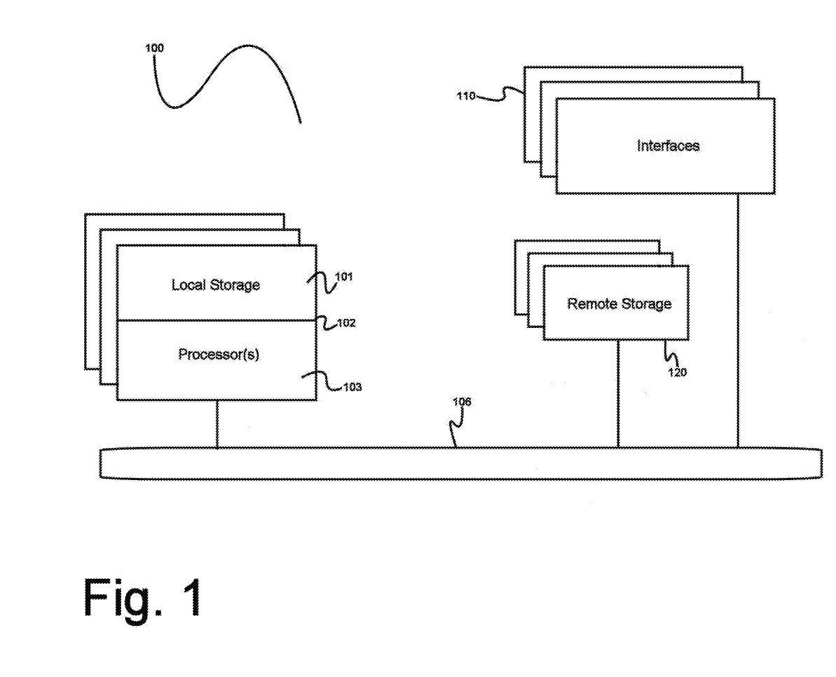

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device, smartphone, or smart watch running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

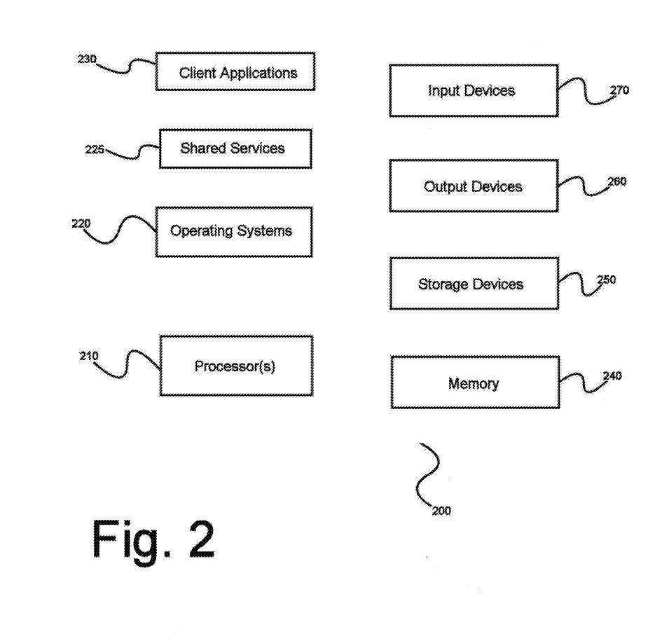

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

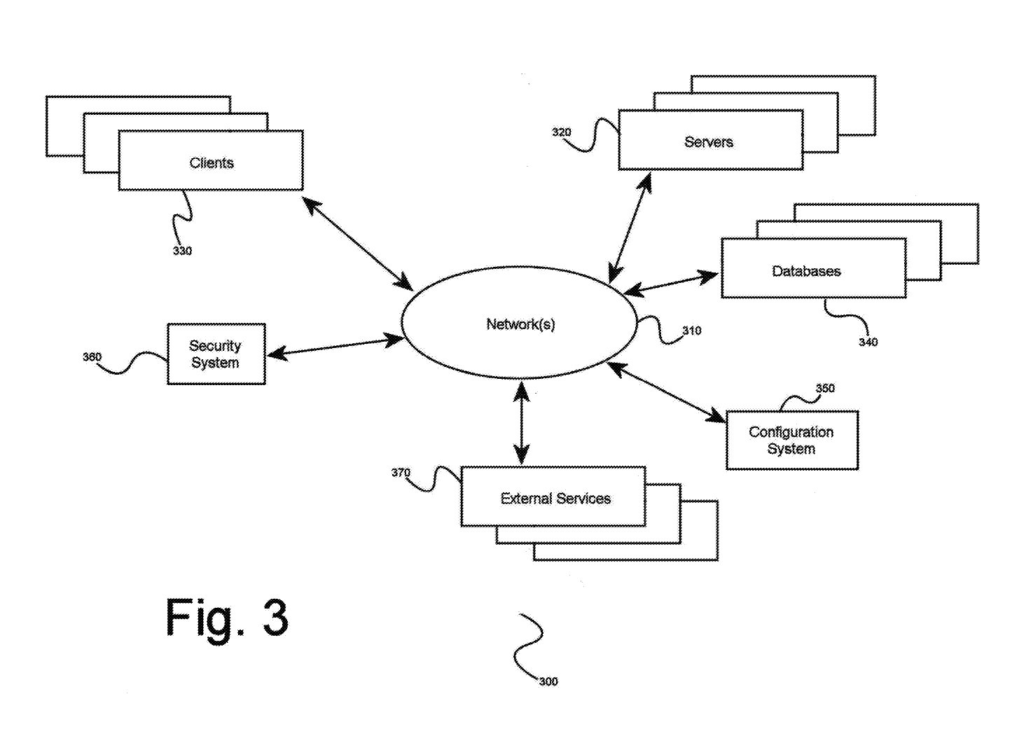

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone, smart watch, or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

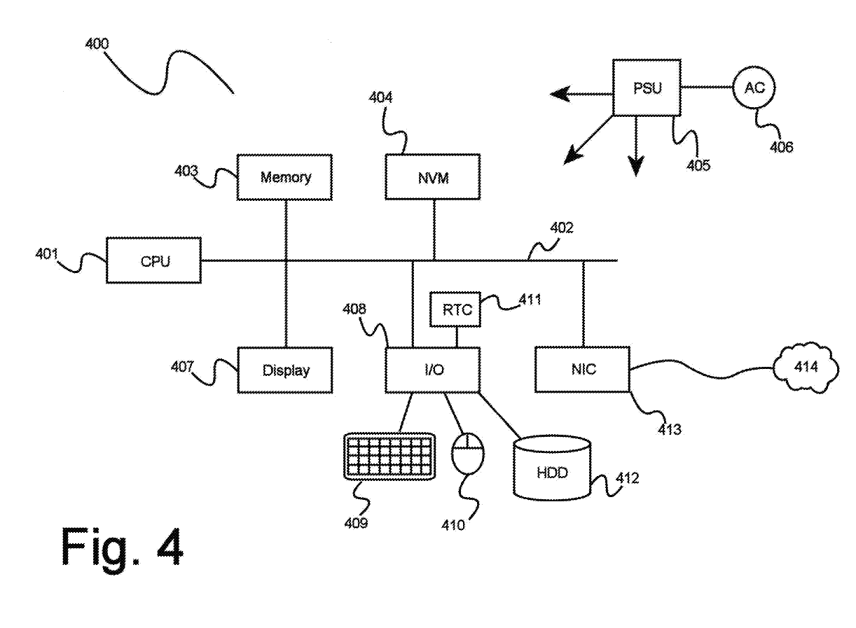

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. Central processor unit (CPU) 401 is connected to bus 402, to which bus is also connected memory 403, nonvolatile memory 404, display 407, input/output (I/O) unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to a main alternating current (AC) supply 406. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

### Conceptual Architecture

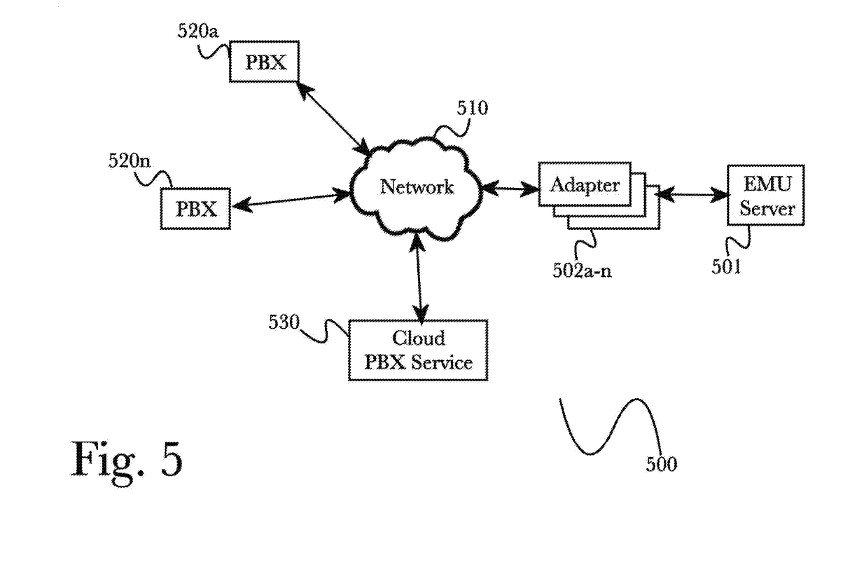

FIG. 5 is an overview of an exemplary system architecture 500 for bulk telephony control system subscriber data manipulation, according to a preferred embodiment of the invention. According to the embodiment, an extraction, manipulation, and update (EMU) server 501 may utilize a variety of communication adapters 502a-n such as including (but not limited to) a software application programming interface (API) 502a, to integrate with a plurality of telephony control system systems (such as, for example, private branch exchanges) 520a-n from different vendors or using different data structures or storage schema (for example, various database architectures such as SQL™ software database schema) over a network 510 such as the Internet or a corporate local area network (for example). Data may be extracted from telephony control system systems 520a-n, optionally manipulated as needed (for example, to migrate data from one data schema to another, or to perform bulk updates to data content), and may then be updated and stored in a telephony control system 520a-n. For example, data may be extracted from a first telephony control system 520a and updated to a second telephony control system 520n to facilitate a data migration operation, or data may be updated to a cloud-based telephony control system 530 offered as a service, to migrate local systems to distributed implementations.

According to the embodiment, an EMU server 501 may be integrated with an existing telephony control system using a number of adapters 502a-n to facilitate communication and data transfer as needed. Adapters 502a-n may also be used to facilitate communication with multiple telephony control systems 520a-n, for example from multiple providers. In such an arrangement, an EMU server 501 may be used to extract information from one telephony control system 520a, modify as needed, and then update the same or an additional telephony control system 520n with the information to migrate customer information between systems or to make additional copies of an existing system. For example, according to the embodiment data may be automatically translated to be compatible with a new system, without necessarily changing any of the information content (for example, when an existing telephony control system reaches end of life and information must be migrated to a new system, but no changes are desired). Similar migration procedures may be used to move installations from legacy telephony control systems to cloud-based systems through data translation and adapters, enabling businesses to rapidly modernize their systems without risking data loss or operational downtime. Another exemplary use may be the retrieval of historical telephony control system information for use in a restore operation to a telephony control system server 520a, to restore the operational server to a prior state such as for backup and restore operations or to copy previously-stored information to a new server. This may be used, for example, to retrieve old backups of telephony control system information, modify the information to bring it in-line with current configurations or policies or to update customer information, and then upload this modified historical data to a telephony control system server for use. For example, this may be useful to restore old customer account information but to correct particular details during the restoration, such as a customer's contact information or the customer's telephony control system feature settings.

According to another arrangement, an EMU server 501 may be utilized to verify information, such as after performing an update to a telephony control system server 520a. For example, test calls may be placed to a telephony control system server 520a to verify information and operation, such as to check that calls are being routed appropriately and subscriber information is intact and correct. Testing reports may be provided to an administrator to audit performance and ensure data integrity, and additional reporting information may be configured as needed such as (for example) to provide more detailed logs of operation or to output all changes made during a migration.

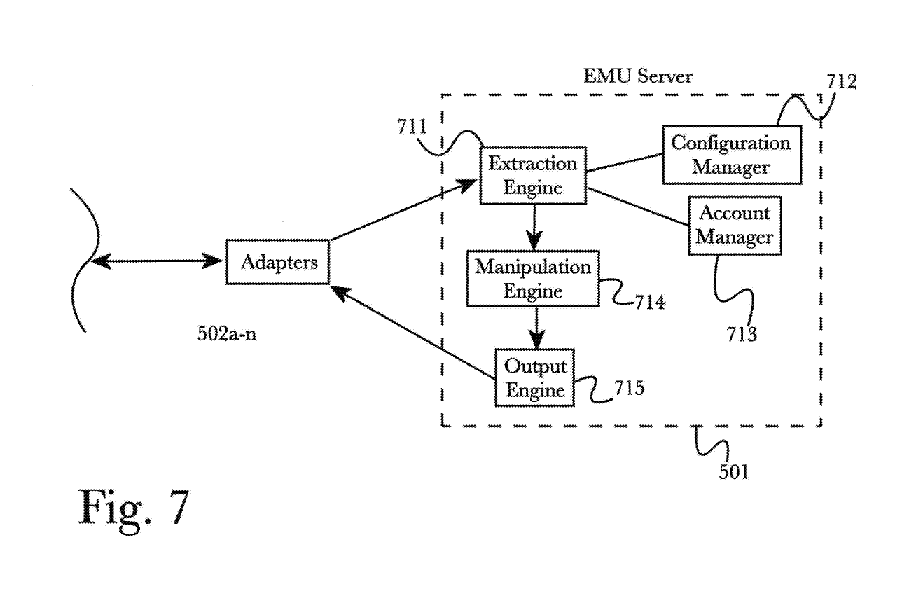

FIG. 7 is a more detailed system architecture diagram of an EMU server 501, illustrating the use of communication adapters and processing modules for EMU operations. According to the embodiment, EMU server 501 may operate a number of modular components to operate on telephony control system information received via a plurality of communication adapters 502a-n, that may be used to facilitate integration with specific client systems (generally telephony control system servers or associated systems for telephony control system operation), such as proprietary systems that may require specific adapters. Information may be received by an extraction engine 711, which may optionally organize received information or perform pre-processing such as to strip out unnecessary data or to adapt information to a suitable format prior to further operation. Extraction engine 711 may also receive data from a configuration manager 712 that may be used to create, store, retrieve, or modify configuration information for EMU operations, such as to define manipulation procedures. Information may also be received from an account manager 713, which may be used to store, provide, and modify account information for clients such as access credentials for specific client sites or systems, as well as to maintain multi-tenancy policies within an EMU server 501 so that a single server may serve multiple clients without risk of exposing their data.

Manipulation engine 714 may be used to perform data manipulation operations on information received by an extraction engine 711, for example to modify customer information or telephony control system configuration data. These operations may be directed in part based on configuration information loaded from a configuration manager 712 or customer account information from an account manager 713. If no manipulation is needed, for example when performing a data migration from one telephony control system to another without changes, manipulation engine 714 may optionally provide data directly to an output engine 715 in a “pass-through” manner without making any modifications. Output engine 715 may then provide received raw or modified data as output via a plurality of adapters 502a-n, for example to upload data to a telephony control system or for storage in a database, or to present data to a user such as via a display adapter or a web browser or a displayed spreadsheet format (for example, to facilitate a “data audit” functionality where a user may review information and manually check operation of an EMU server or a telephony control system server).

### DETAILED DESCRIPTION OF EXEMPLARY EMBODIMENTS

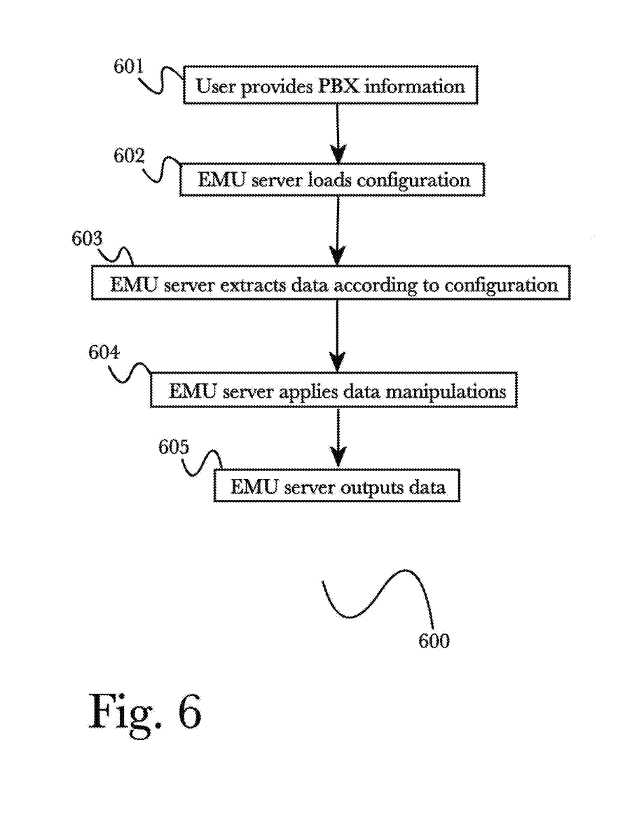

FIG. 6 is a process flow diagram illustrating an exemplary telephony control system migration process 600 using bulk data manipulation, according to a preferred embodiment of the invention. According to the embodiment, in an initial step 601 a business may provide telephony control system information to an EMU server such as (for example) version, database schema, or access information such as login credentials (or any other such information that may be necessary or helpful in performing EMU operations). In a next step 602, an EMU server may then load a configuration, optionally either from a stored configuration or from user input (for example, to run a single operation by manually instructing the EMU server, as opposed to a stored configuration for automated or scheduled operation). In a next step 603, the EMU server may then extract data from a telephony control system according to the loaded configuration, for example by performing a scheduled operation based on a stored configuration or by performing one-time operations based on user input (for example, for performing small operations or for testing or auditing). In a next step 604, the EMU server may display the extracted data in any visual forms (on screen, spreadsheet, text file, etc.), apply any specified manipulations to the data (or manipulations may be made by users directly and handled by the EMU server), such as modifying customer information or adding or removing entries, and in a final step 605 may output the data for storage or review (for example, to update the telephony control system from which the data was extracted, or to migrate data into a new telephony control system server, or to present a report on operation for review by an administrator or other user).

The skilled person will be aware of a range of possible modifications of the various embodiments described above. Accordingly, the present invention is defined by the claims and their equivalents.

What is claimed is:

1. A system for bulk telephony control system subscriber data manipulation, comprising:
an extraction, manipulation, and update (EMU) server comprising at least a plurality of programming instructions stored in a memory and operating on a processor of a network-connected computing device and configured to:
receive a plurality of information via a network, at least a portion of the information comprising telephony control system subscriber data;
analyze at least a portion of the information;
determine whether to modify at least a portion of the telephony control system subscriber data, the determination being based at least in part on the analysis;
apply any determined modifications to at least a portion of the telephony control system subscriber data; and
provide at least a portion of the information as output; and
a plurality of communication adapters, each comprising at least a plurality of programming instructions stored in a memory and operating on a processor of a network-connected computing device and configured to facilitate communication between the EMU server and a third-party system.

2. The system of claim 1, wherein the operation of the EMU server is directed based at least in part on configuration information received by the EMU server.

3. The system of claim 2, wherein at least a portion of the configuration information is retrieved from a data storage.

4. The system of claim 2, wherein at least a portion of the configuration information is provided manually by a user.

5. The system of claim 1, wherein the plurality of communication adapters comprises at least a software application programming interface configured to facilitate communication between the EMU server and a computing device.

6. A method for bulk telephony control system subscriber data manipulation, comprising the steps of:
receiving, at an extraction, manipulation, and update (EMU) server comprising at least a plurality of programming instructions stored in a memory and operating on a processor of a network-connected computing device, a plurality of information;
extracting at least a plurality of telephony control system subscriber data from the information;
applying a plurality of data manipulations to at least a portion of the telephony control system subscriber data; and
providing at least a portion of the telephony control system subscriber data as output.

7. The method of claim 6, further comprising the step of loading a configuration, wherein the extraction is based at least in part on the loaded configuration.

8. The method of claim 7, wherein the data manipulations are applied based at least in part on the loaded configuration.

9. The method of claim 7, wherein the configuration is retrieved from a data storage.

10. The method of claim 7, wherein the configuration is input manually by a human user.
